(19) United States
(12) Patent Application Publication
(10) Pub. No.: US 2024/0274834 A1
(43) Pub. Date: Aug. 15, 2024

(54) CONDUCTIVE CURRENT COLLECTOR FOR BIPOLAR BATTERY

(71) Applicant: Gridtential Energy, Inc., Santa Clara, CA (US)

(72) Inventors: Collin Kwok Leung Mui, Mountain View, CA (US); Peter Gustave Borden, San Mateo, CA (US)

(21) Appl. No.: 18/533,761

(22) Filed: Dec. 8, 2023

Related U.S. Application Data
(63) Continuation of application No. PCT/US2022/032887, filed on Jun. 9, 2022.
(60) Provisional application No. 63/277,070, filed on Nov. 8, 2021.
(60) Provisional application No. 63/210,207, filed on Jun. 14, 2021.

(51) Int. Cl. H01M 4/66; H01M 4/02; H01M 4/68; H01M 4/75

(52) U.S. Cl. CPC H01M 4/667; H01M 4/662; H01M 4/664; H01M 4/68; H01M 4/75; H01M 2004/029

(57) ABSTRACT

A conductive current collector with modified surfaces can be included as a portion of a bipolar battery assembly. The modification process can include deposition or formation of a thin-film layer such as metal silicide or a metal nitride on a surface of the current collector. As an illustration, metal silicides can be created by co-sputtering or by annealing after deposition of one or more of a silicon or a metal layer. Additional layers can be provided, such as to facilitate adhesion of an active material to a current collector having a silicide or nitride surface.

### CLAIM OF PRIORITY

This patent application is continuation of Mui et al., International Application No. PCT/US2022/032887, titled “CONDUCTIVE CURRENT COLLECTOR FOR BIPOLAR BATTERY,” filed on Jun. 9, 2022 (Attorney Docket No. 3601.021WO1), which claimed the benefit of priority of Collin Kwok Leung Mui, U.S. Provisional Patent Application No. 63/210,207, titled “CONDUCTIVE CURRENT COLLECTOR FOR BIPOLAR BATTERY,” filed on Jun. 14, 2021 (Attorney Docket No. 3601.021PV2) and the benefit of priority of Mui et al., U.S. Provisional Patent Application No. 63/277,070, titled “CONDUCTIVE CURRENT COLLECTOR FOR BIPOLAR BATTERY,” also filed on Nov. 8, 2021 (Attorney Docket No. 3601.021PV3), the benefit of each of which is hereby is hereby presently claimed, and the entireties of each of which are hereby incorporated by reference herein.

### FIELD OF THE DISCLOSURE

This document pertains generally, but not by way of limitation, to battery assemblies, such as lead-acid battery assemblies, and more particularly to materials and processing techniques, such as can be used to provide a current collector having a conductive (e.g., metal or metal alloy) substrate that can be used to form a portion of a bipolar battery.

### BACKGROUND

The lead acid battery, invented by Gaston Planté in 1859, can be considered the oldest and most common type of secondary (e.g., rechargeable) battery. Applications for lead acid batteries include automotive (e.g., starting, ignition, and lighting), traction (e.g., vehicular drive), and stationary (e.g., back-up power supply) applications. Despite simplicity and low cost, generally-available monopolar lead acid technology has several shortcomings related to architecture and materials used in the battery. For example, generally-available monopolar lead acid batteries have relatively lower energy densities as compared to other chemistries such as lithium ion partly because the lead alloy grids do not contribute to energy storage capacity. Also, cycling performance of monopolar lead acid batteries may be poor under high-current-rate or deep discharge conditions. In addition, monopolar lead acid batteries may suffer from poor partial-state-of-charge performance, and often have high self-discharge rates relative to other technologies.

### SUMMARY OF THE DISCLOSURE

As mentioned above, lead acid batteries can be constructed in a “monopolar” configuration. In the monopolar configuration, cells are generally arranged electrically in parallel to multiply the cell capacity, and a predominant current flow occurs in a direction parallel to the surface of the battery electrode plates. However, as discussed above, generally-available lead acid technology has several shortcomings related to its monopolar configuration. In general, current collectors for monopolar lead acid batteries are specified to be good electrical conductors, mechanically strong, and resistant to sulfuric acid corrosion. Alloying elements include antimony, calcium, or tin, as illustrative examples. The composition of the alloy is controlled to increase mechanical strength and control corrosion rate of the lead grid current collector. To construct a monopolar lead acid battery, positive and negative active materials are pasted on current collector grids and cured to become plates. A single monopolar cell generally includes a positive plate and a negative plate, such as with a separator in between the plates. A multi-cell stack is obtained by connecting single cells in parallel using separate conductors. Many trace elements can form compounds with the lead alloy grid or promote side reactions during battery operation. As side reactions compete with the electrochemical reactions of charging and discharge, “symptoms” can appear such as low efficiency, high self-discharge, and poor partial state of charge, during monopolar battery operation.

By contrast, a bipolar battery architecture offers improvements over a monopolar battery configuration. In a bipolar configuration, cells are arranged electrically in series to multiply the cell voltage without requiring separate conductors to connect the cells; current flows in a direction generally perpendicular to a surface of the bipolar battery plates. Fabrication of a bipolar battery generally involves forming a bipolar current collector starting from a substrate material (e.g., a conductive substrate). Positive and negative active materials are applied to at least a portion of opposite surfaces of the bipolar current collector to provide a bipolar plate or “biplate.” Multiple bipolar plates can be compressed and stacked alternately with separators to establish individual cell compartments, which are to be isolated from each other. Each cell compartment is saturated or partially saturated with a liquid or gel electrolyte, then the battery stack can be formed to activate the cathode and anode materials. In the bipolar configuration, the current collector itself (e.g., the conductive substrate) provides an inter-cell electrical connection, with the anode of one cell conductively coupled to the cathode of the next cell on the opposite side of the bipolar current collector via the current collector substrate.

In one approach, materials used in monopolar lead acid batteries can be used as current collectors for a bipolar battery. For example, a bipolar current collector can use lead or lead alloy sheets to form the current collector. However, lead is a relatively soft and heavy metal, and lead also corrodes slowly in sulfuric acid. As a lead sheet current collector deforms and corrodes inside the bipolar lead acid battery, the battery performance can suffer, or the battery may entirely fail. Although alloying can improve the mechanical strength and decrease a corrosion rate of a lead sheet, it does not reduce weight. Moreover, challenges may exist in forming a hermetic edge seal around a bipolar current collector made exclusively from a lead or lead alloy, as most filler metals for soldering or brazing also corrode in sulfuric acid. Various metals may not be entirely suitable as current collectors for bipolar lead acid batteries because of corrosion risks (Cu, Sn, Pb), passivation (Al, Ti), low over-potential for hydrogen evolution (Ni, Fe), or cost (Ag, Au, Pt).

In another approach, composite materials can be used as the current collector. Composite materials can have superior mechanical properties, resistance to corrosion, and certain materials can be relatively electrochemically stable. However, most constituents of composite materials are poor electrical and thermal conductors. Because the processing of composite materials generally includes molding multiple constituents with different physical properties, microscopic voids may be found inside a material matrix. These porous defects can act as nucleation sites to promote crack formation and propagation, which can become micro-channels for electrolyte diffusion. When a bipolar battery is charged and discharged repeatedly, mechanical, and thermal stress developed inside the battery can accelerate crack formation and propagation to increase electrolyte diffusion rates through the current collectors. This can result in rapid capacity loss and short battery life when composite current collector substrates are used.

The present inventors have recognized, among other things, that properties of the substrate in bulk and of a surface of a substrate can be specified independently. Substrate properties can be specified to provide low resistivity, high thermal conductivity, and for example, if metallic, resistance to electrolyte diffusion. Surface properties can be specified to include corrosion resistance and a suitable (e.g., “wide”) electrochemistry window of operation. Accordingly, a suitable bipolar current collector can be fabricated by modifying the surface of a suitable substrate to render its surface electrochemically stable and corrosion resistant in a bipolar lead-acid battery application.

In an example, a current collector for a bipolar lead acid battery can be conductive, such as metallic, the metallic current collector comprising a conductive metallic substrate other than silicon, and at least one thin-film contact layer comprising a conductive silicide or a conductive nitride. Generally, in a bipolar battery plate application, a first surface of the metallic current collector comprises a first active material having a first polarity and an opposite second surface of the metallic current collector comprises a second active material having an opposite second polarity. The at least one thin-film contact layer can include a conductive silicide or a conductive nitride of a metallic species forming the conductive metallic substrate, or a species different from a metallic species forming the conductive substrate. The current collector can include at least one adhesion layer, such as located between an active material layer and at least one thin-film contact layer, the at least one adhesion layer comprising lead, tin, a lead-tin alloy, or another lead-containing alloy.

In an example, a method for providing collector, such as a metallic current collector, can include forming at least one thin-film contact layer on a surface of a conductive metallic substrate, the at least one thin-film contact layer comprising a conductive silicide or a conductive nitride, the conductive metallic substrate other than silicon, and, optionally, forming at least one adhesion layer comprising at least one of lead or tin, wherein the forming the at least one thin-film contact layer comprises at least one of (1) deposition or (2) annealing. The adhesion layer can be deposited by electroplating, such as followed by application of further adhesion layer material using a technique other electroplating. Other techniques can be used for forming the adhesion layer, such as application of the adhesion layer to the at least one thin-film contact layer thermally, or using compression, or using a combination of thermal application and compression forces. In another example, the adhesion layer is applied using a lamination process or screen printing.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A illustrates generally an example showing a monopolar battery architecture.

FIG. 1B illustrates generally an example showing a battery assembly having a bipolar architecture.

FIG. 2A and FIG. 2B show views of an example comprising processing of a conductive metallic current collector, such as including deposition of silicon, and formation of a metal silicide where the metallic species is the material of the substrate of the conductive metallic current collector.

FIG. 3A and FIG. 3B generally illustrate views of an example comprising processing of a conductive metallic current collector, such as including deposition a metal and silicon, where the metal can differ from a metallic species comprising the substrate of the conductive current collector.

FIG. 4A, FIG. 4B, FIG. 4C, and FIG. 4D show illustrative examples of phase diagrams for various metal-silicon binary systems which form different metal silicide phases, with FIG. 4A showing Cobalt-Silicon (Co—Si), FIG. 4B showing Tantalum-Silicon (Ta—Si), FIG. 4C showing Nickel-Silicon (Ni—Si), and FIG. 4D showing Titanium-Silicon (Ti—Si).

FIG. 5A and FIG. 5B show illustrative examples of phase diagrams for various metal-silicon binary systems which do not form metal silicides, with FIG. 5A showing Lead-Silicon (Pb—Si), and FIG. 5B showing Tin-Silicon (Sn—Si).

FIG. 6A and FIG. 6B show illustrative examples comprising cyclic voltammetry spectra of tantalum disilicide (TaSi₂) and nickel silicide (NiSi) layers.

FIG. 7 shows an illustrative example of processing of a conductive metallic current collector, such as including forming a contact layer, and forming an adhesion layer.

FIG. 8 illustrates generally a technique, such as a method, for providing a metallic current collector for a bipolar lead acid battery.

### DETAILED DESCRIPTION

In a bipolar battery assembly, electrochemical cells are connected electrically in series, generally through the current collector substrate. In this manner, a negative electrode of one cell is connected to provide the positive electrode of the next cell. Individual electrochemical cells in a bipolar lead acid battery can be hermetically sealed from each other to prevent an inter-cell short circuit and capacity loss for issues such as electrolyte leakage. A bipolar configuration can provide a uniform current density distribution within the current collector. Contrary to the monopolar configuration where current can flow parallel to the surface of the plates, current generally flows in a perpendicular direction through the bipolar current collector (e.g., from one large surface or face of the current collector plate to an opposite surface).

Accordingly, a current density distribution on a bipolar plate can be determined predominantly by intra-cell non-uniformity because there is no extra potential difference across the surface of the plate. A uniform current distribution can reduce or minimize sulfation especially under high-current-rate or deep discharge conditions because the plate surface is generally at a constant potential. In addition, a bipolar structure is generally a high voltage and low current device. As ohmic losses scale with the square of the current, the bipolar battery generally provides comparatively lower ohmic losses at high power versus a monopolar configuration. Accordingly, bipolar lead acid technologies generally offer not only higher energy and power densities as compared to monopolar cell configurations and can also provide superior cycling performance under high-current-rate and deep discharge conditions.

A conductive current collector for use in a bipolar battery application is shown and described herein. The current collector can be included as a portion of a bipolar battery assembly. Generally, the current collector comprises a conductive substrate and a surface that is compatible with lead-acid electrochemistry. The substrate material can be a metal or can otherwise include a metallic species, such as comprising a modified surface.

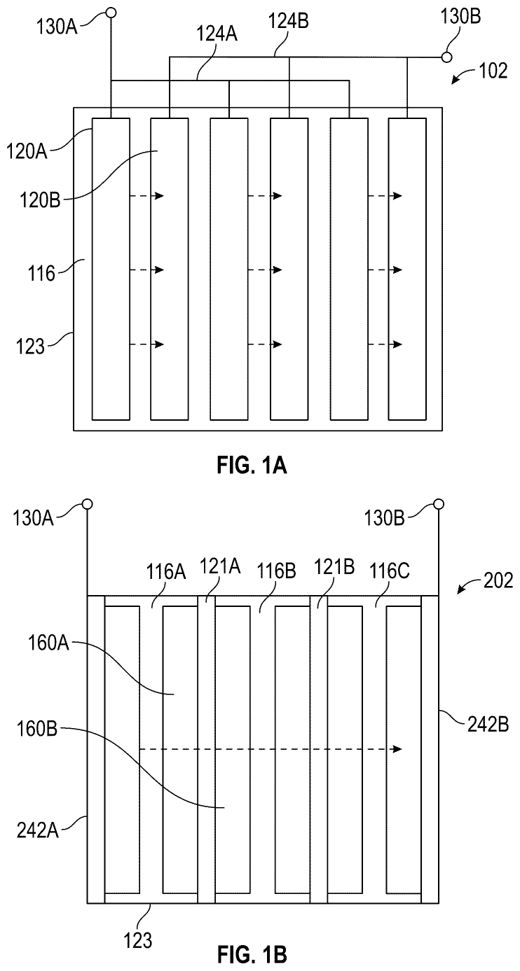

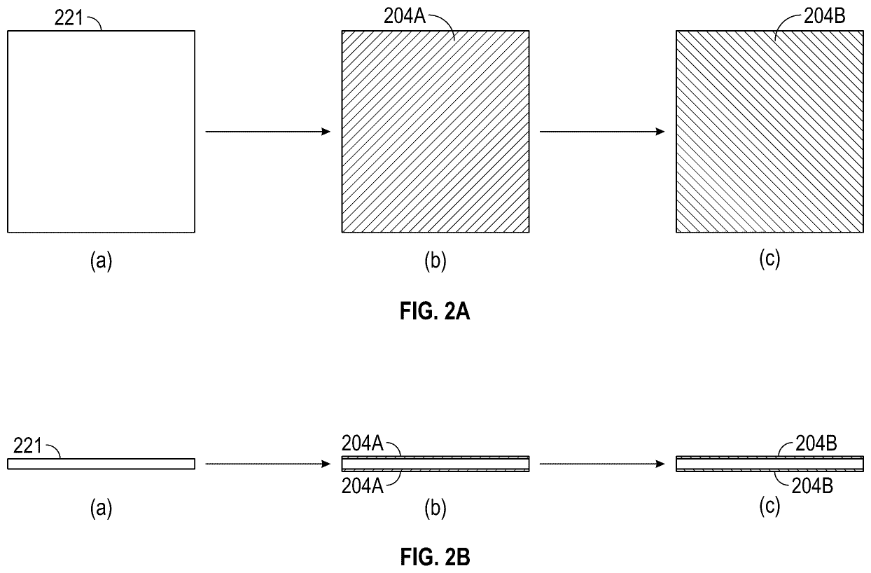

FIG. 1A illustrates generally an example that can include a monopolar battery architecture. In a monopolar configuration, a current collector generally includes an active material of a single polarity (e.g., positive or negative) applied to both (e.g., opposite) sides of the current collector, such as including application of the active material in paste form. A positive-negative pair can be formed such as including the first plate 120A having a first polarity active material and a second plate 120B having an opposite second polarity active material, to form an electrochemical cell when surrounded in an electrolyte in region 116, such as shown illustratively in FIG. 1A. In a lead-acid example, such a single-cell voltage can be around 2.1V. Multiple cells can be arranged electrically in parallel configuration as a stack (e.g., a plate block). Individual stacks through can be connected in series to provide a battery assembly 102. In FIG. 1A, a first terminal 130A can establish a first polarity, and a second terminal 130B can establish an opposite second polarity.

FIG. 1B illustrates generally an example showing a battery assembly 202 having a bipolar architecture. In the bipolar configuration, because cells are arranged electrically in series to multiply the cell voltage, current flows in a direction generally perpendicular to the surface of the current collector plates. Generally, fabrication of a bipolar battery involves forming a current collector comprising a substrate material (e.g., a conductive substrate) where positive and negative active materials are applied to at least a portion of opposite surfaces of the current collector to provide a bipolar plate or “biplate.” Generally, multiple bipolar plates are compressed and stacked alternately with separators to establish individual cell compartments, which are to be isolated from each other. Each cell compartment is filled with a liquid or a gel electrolyte, then the battery stack can be formed to activate the cathode and anode materials. In the bipolar configuration, the current collector itself (e.g., the conductive substrate) provides inter-cell electrical connection, with the anode of one cell conductively coupled to the cathode of the next cell on the opposite side of the bipolar current collector via the current collector substrate.

Referring to FIG. 1B, a bipolar architecture can provide a simpler configuration as compared to a monopolar architecture. Respective positive and negative active materials (e.g., active materials represented by regions 160A and 160B) can be applied, such as through pasting, onto opposite sides of a current collector (e.g., plate 121A) to form a bipolar plate. As in FIG. 1A, a first terminal 130A can provide a first polarity, and a second terminal 130B can provide an opposite second polarity. Such terminals 130A and 130B can be connected to end electrodes 242A and 242B directly, respectively. The bipolar plates 121A, 121B can be arranged in a stacked configuration with electrolyte in regions 116A, 116B, and 116C for example, to form sealed cells within a casing 123. In an example, an electrolyte in region 116A can be one or more of fluidically isolated or hermetically sealed so that electrolyte cannot bypass the bipolar plate 121A to an adjacent region such as the electrolyte region 116B. Such isolation or sealing (or both) can suppress or inhibit leakage of electrolyte from the assembly 202. As shown illustratively in FIG. 1B, cells can be arranged in a series configuration forming a stack to achieve a specified terminal 130A, 130B voltage, without requiring internal bus structures. As an illustrative example, each bipolar plate can be mechanically attached to a casing portion (e.g., a modular casing frame), such as supporting a bipolar plate and having a modular (e.g., stackable) configuration.

Performance of a bipolar lead acid battery can be influenced significantly by the materials and fabrication used for the current collector, and particularly the substrate material. Bipolar current collectors generally have more stringent material specifications than their monopolar counterparts. In addition to providing electrical conductivity, mechanical robustness, and resistance to sulfuric acid corrosion, the current collector for bipolar lead acid batteries is also generally specified to be impervious or insulated against electrolyte diffusion, to be electrochemically stable within the operating range of lead acid chemistry, and to dissipate heat by conduction

A conductive current collector, such as comprising a modified surface, is shown and described herein. The current collector can be included as a portion of a bipolar battery assembly. Generally, the current collector comprises a conductive substrate and a surface that is compatible with lead-acid electrochemistry. The substrate material can be a metal or can otherwise include a metallic species. A thin-film can be deposited, formed, or applied to a mechanically robust and electrically conductive substrate to achieve a combination of specified mechanical, electrical, thermal, and electrochemical properties. Generally, the surfaces of the conductive current collector substrate can be enhanced by a conductive contact layer to provide corrosion resistance in operation with lead-acid battery chemistry. The contact layer can be a metallic thin film, a metal silicide thin film, a conductive nitride thin film, or other thin film such as a carbide or an oxide. The contact layer can be a mixed-layer structure such as a silicide/nitride mixed-layer structure or a carbide/oxide mixed-layer structure, as illustrative examples.

As an illustrative example, thin-film deposition processing can be used to apply an electrochemically-compatible contact layer onto one or both surfaces of a conductive metallic substrate. The surface layer can be a metal silicide formed by annealing a deposited silicon thin film on the substrate, a metal silicide directly deposited onto the substrate, or a metallic thin film, as illustrative examples. In another example, a metal nitride can be formed as an electrochemically compatible conductive contact layer.

In an example, a conductive metallic current collector can be fabricated from an electrically conductive workpiece. A substrate with specified dimensions and thickness can be formed or otherwise provided, such as for use as a base material for a conductive metallic current collector in a “biplate” assembly. Dimensions of a conductive metallic current collector used for a bipolar lead acid battery can vary, as can a shape of such a conductive metallic current collector. As an illustrative example, a conductive metallic current collector can have dimensions of about 200 millimeters, square, about 300 millimeters, square, or about 200 millimeters by 300 millimeters to provide a rectangular geometry. Other dimensions can be used, such as larger dimensions for stationary or high-capacity applications (e.g., grid energy storage), or smaller dimensions for compact battery assemblies, or to otherwise fit within standard battery size formats. For example, substrate dimensions can be specified to match an available size of solar-grade silicon wafers, so that the substrates can be processed in standardized processing equipment.

Because different materials have different mechanical properties, the thickness of the conductive metallic current collector can vary from about 100 micrometers to about 2000 micrometers, according to various illustrative but non-limiting examples. Larger current collectors (e.g., conductive metallic current collector having larger surface area) are generally thicker. Generally, the substrate can include a metallic species. Certain metals can form silicides with silicon, such as including but not limited to, titanium (Ti), chromium (Cr), iron (Fe), cobalt (Co), nickel (Ni), copper (Cu), niobium (Nb), molybdenum (Mo), tantalum (Ta), tungsten (W), platinum (Pt), or zirconium (Zr). Some metals, including lead (Pb) and tin (Sn), however, do not form silicides. The example of a homogeneous substrate is illustrative and other substrate configurations can be used. For example, the current collector can include a laminate structure, such as including multiple conductive layers. For example, the substrate can include iron, and can have a thin nickel layer, with a conductive silicide formed on the nickel surface.

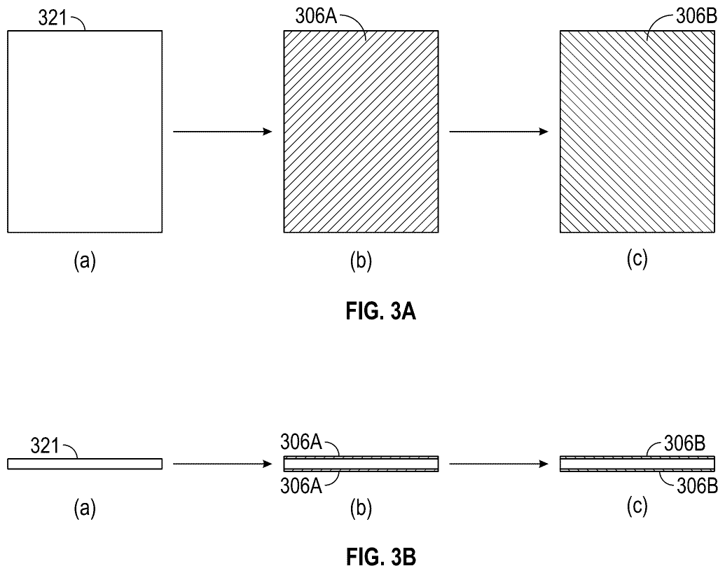

FIG. 2A and FIG. 2B show views of an example comprising processing of a conductive metallic current collector 221, such as including deposition of silicon 204A, and formation of a metal silicide 204B where the metallic species is the material of the substrate of the conductive metallic current collector 221 (or at least a material of the surface of the substrate). Generally, the substrate (e.g., a metallic substrate) is cleaned at (a) prior to silicon deposition at (b). The metal-silicon interface is generally clean and oxide-free prior to silicide formation at (c), because a contaminated interface could affect a subsequent silicide formation process. Such formation at (c) with a contaminated interface could result in silicide film delamination. Many cleaning processes can be used to clean different metal surfaces, including solvent cleaning, alkaline detergent cleaning, acid etching, or ultrasonic cleaning. A sequence of cleaning procedures may be used to achieve a specified surface cleanliness.

Silicon can be deposited on one or both surfaces of the conductive metallic current collector 221 at (b), such as where the conductive metallic current collector 221 comprises a material other than elemental silicon. Silicon can be deposited at (b) by physical vapor deposition, or by plasma enhanced chemical vapor deposition, as illustrative examples. Some deposition equipment can be integrated with a “pre-clean” module, in which the conductive metallic current collector 221 is cleaned under vacuum either by sputtering or by etching. Pre-cleaning of the conductive metallic current collector 221 ensures that a surface is atomically clean prior to silicon deposition at (b), which facilitates subsequent silicide formation at (c). Although epitaxial silicon can be deposited on semiconductor surfaces, silicon deposited by physical vapor deposition or plasma enhanced chemical vapor deposition is typically multi crystalline or amorphous. For the purpose of silicide formation, a multi crystalline or amorphous silicon layer may be used.

After silicon deposition at (b), the conductive metallic current collector 221 can be annealed at high temperature such that the metal silicide 204B can be formed by sintering. During a sintering process, metal and silicon atoms generally diffuse across the silicon-metal interface and react to from metal silicide. When the sintering process is completed, a portion or entirety of silicon atoms are consumed to form a continuous metal silicide layer fused on the surfaces of the conductive metallic current collector 221. Annealing is generally performed under an inert atmosphere, such that oxidation is not occurring during the silicide formation process at (c).

Some silicides have multiple phases, and the phases can have different properties such as bulk electrical resistivity and over-potential for hydrogen or oxygen evolution from the surfaces. Different phases of a silicide can be obtained by annealing at different temperatures. Accordingly, using control of the annealing temperature, a desired metal silicide phase can be obtained. Examples of silicides and corresponding physical properties are shown illustratively in TABLE 1, below. In TABLE 1, metal and corresponding silicide phases with low electrical resistivities are listed. The columns ρM and ρS denote the electrical resistivities of the metal and the metal silicide, respectively. A ratio tS/tM is a ratio of the silicide film thickness to the original metal film thickness.

TABLE 1
Properties of Metal Silicides.

| | | | | RTP | |
|---|---|---|---|---|---|
| | | | | Anneal | |
| | | ρM | ρS | Temp. | |
| Metal | Silicide | (μΩcm) | (μΩcm) | (° C.) | t_{S}/t_{M} |
| Ti | C49-TiSi₂ | 42 | 60-70 | 500-700 | 2.51 |
| Ti | C54-TiSi₂ | 42 | 13-16 | 700-900 | 2.51 |
| Co | Co₂Si | 6.24 | 70 | 300-500 | 1.47 |
| Co | CoSi | 6.24 | 100-150 | 400-600 | 2.02 |
| Co | CoSi₂ | 6.24 | 14-20 | 600-800 | 3.52 |
| Ni | Ni₂Si | 6.93 | 22-26 | 270-300 | 1.83 |
| Ni | NiSi | 6.93 | 14-20 | 400-600 | 2.34 |
| Ni | NiSi₂ | 6.93 | 40-50 | 600-800 | 3.63 |
| Mo | C11b-MoSi₂ | 5.34 | 40-100 | 800-1000 | 2.59 |
| Ta | C40-TaSi₂ | 13.1 | 35-55 | 800-1000 | 2.41 |
| W | C11b-WSi₂ | 5.28 | 30-70 | 1000 | 2.58 |
| Pt | PtSi | 10.6 | 28-35 | 250-400 | 1.97 |

In an example, such as instead of silicon deposition, the current collector substrate can be annealed at high temperature in a nitrogen atmosphere such that a metal nitride is formed on a surface of the substrate. Accordingly, the subject matter herein is not restricted to formation of silicides as a thin-film contact layer.

In an example, the substrate comprises a conductive material such as (1) a metal such as aluminum (Al), copper (Cu), lead (Pb), nickel (Ni), tin (Sn), titanium (Ti), iron (Fe), or tantalum (Ta); (2) an alloy such as carbon steel (e.g., a mild steel), stainless steel, a Hastelloy® material or the like (e.g., an alloy comprising nickel-molybdenum or comprising nickel-chromium-molybdenum, or consisting essentially of nickel-molybdenum or consisting essentially of nickel-chromium-molybdenum), an Ultimet® material or the like (e.g., an alloy comprising cobalt-chromium-nickel-iron, or consisting essentially of cobalt-chromium-nickel-iron), or a Monel® material (e.g., an alloy comprising nickel-copper, or an alloy consisting essentially of nickel-copper); or (3) another electrically conductive substrate, such as having a resistivity of 0.1 milli-ohm-centimeter (mΩcm) or less, and no more than 2 mΩcm, as illustrative examples.

In an example, a conductive metallic current collector such as comprising a metal or an alloy, or other electrically conductive substrate, can be processed, such as by direct deposition of a thin layer of a metal silicide on one or more surfaces of the substrate. Such deposition can be performed, for example, using a thin-film deposition technique such as physical vapor deposition, chemical vapor deposition, or electrodeposition. As illustrative examples, silicides of molybdenum (Mo) or tantalum (Ta) can be deposited by sputtering sourced from a composite target, and tungsten disilicide (WSi₂) can be deposited by chemical vapor deposition. Accordingly, in some examples a silicide can be deposited directly without a separate silicon deposition step. A thickness of a deposited metal silicide can be as thin as 100 nanometers, for example.

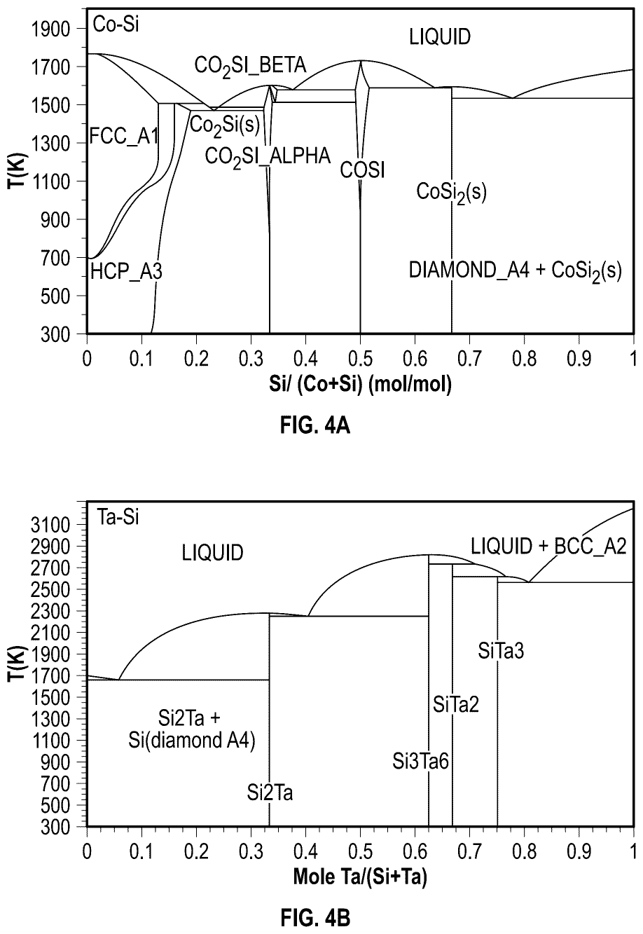

FIG. 3A and FIG. 3B generally illustrate views of yet another example comprising processing of a conductive metallic current collector 321, such as including deposition a metal and silicon layer 306A at (b), where the metal can differ from a metallic species comprising the substrate of the conductive current collector. A silicide 306B can be formed at (c). The conductive metallic current collector 321 can be proceed at (a), such as cleaned. At (b), a metal can be deposited and silicon can be deposited, such as sequentially, where either metal deposition occurs first or silicon deposition occurs first. Generally, as shown in the processing of FIG. 3A and FIG. 3B, a metal silicide can be formed on a substrate surface by first depositing a thin layer of silicide-forming metal such as titanium (Ti), chromium (Cr), iron (Fe), cobalt (Co), nickel (Ni), copper (Cu), niobium (Nb), molybdenum (Mo), tantalum (Ta), tungsten (W), platinum (Pt), or zirconium (Zr), for example, followed by deposition of silicon thin film and annealing. Alternatively, the metal silicide can be formed on a substrate surface using a sequence of silicon deposition, metal deposition, and annealing. In such an example, a melting point of the substrate should generally be higher than a sintering temperature of the metal silicide. As mentioned above, the substrate need not be uniform and can include a laminated structure, such as, for example an aluminum substrate that is clad or layered with nickel or tin, such as formed by lamination or plating. As an illustrative example, the substrate could include an aluminum core material clad with nickel (e.g., having a nickel-aluminum-nickel stack-up).

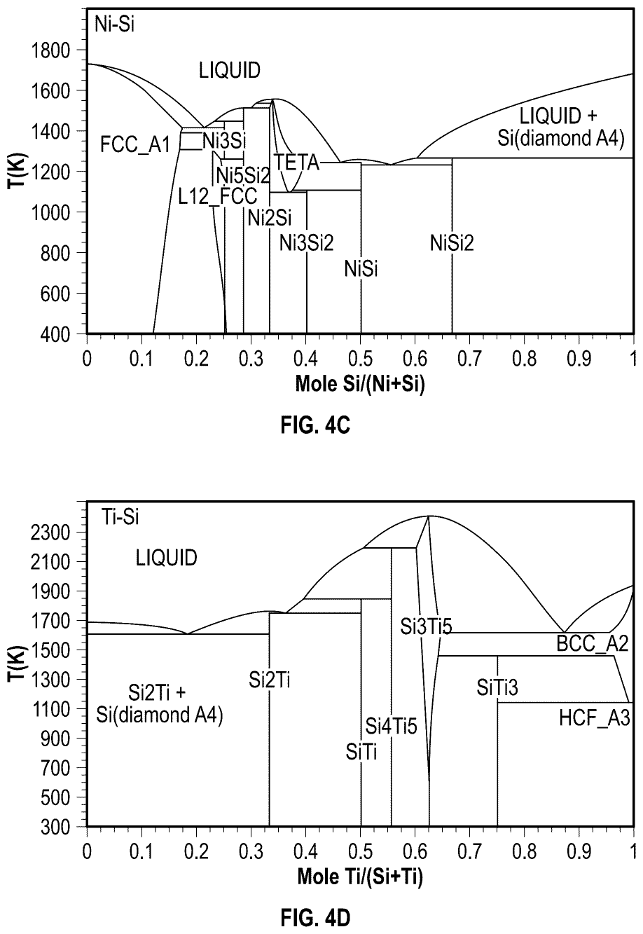

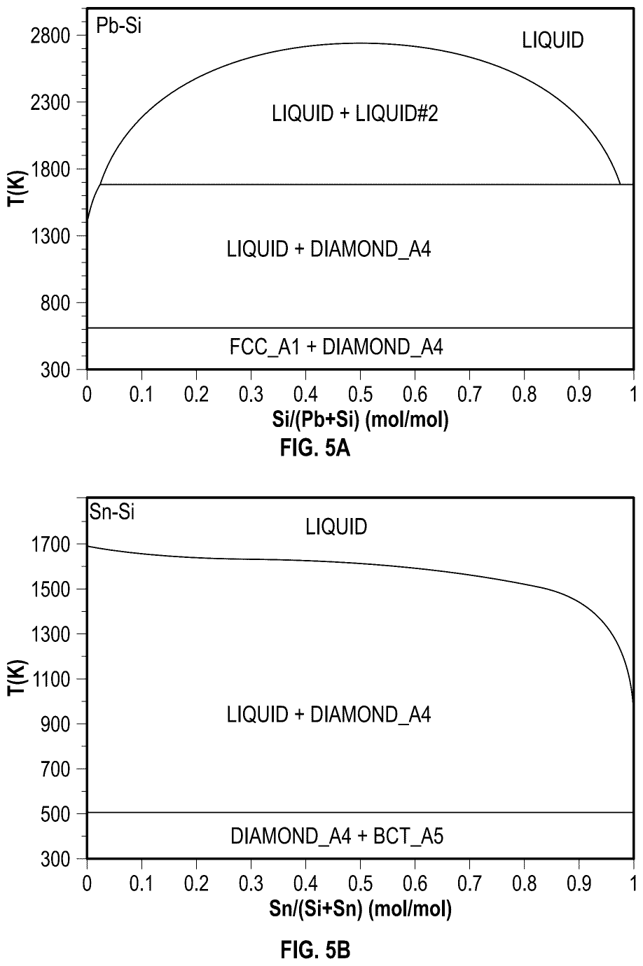

FIG. 4A, FIG. 4B, FIG. 4C, and FIG. 4D show illustrative examples of phase diagrams for various metal-silicon binary systems which form different metal silicide phases, with FIG. 4A showing Cobalt-Silicon (Co—Si), FIG. 4B showing Tantalum-Silicon (Ta—Si), FIG. 4C showing Nickel-Silicon (Ni—Si), and FIG. 4D showing Titanium-Silicon (Ti—Si). Such phase diagrams illustrate generally that a variety of metallic silicides can be formed such as using the processing of either FIG. 2A and FIG. 2B, or FIG. 3A and FIG. 3B, as illustrative examples. By contrast, FIG. 5A and FIG. 5B show illustrative examples of phase diagrams for various metal-silicon binary systems which do not form metal silicides, with FIG. 5A showing Lead-Silicon (Pb—Si), and FIG. 5B showing Tin-Silicon (Sn—Si).

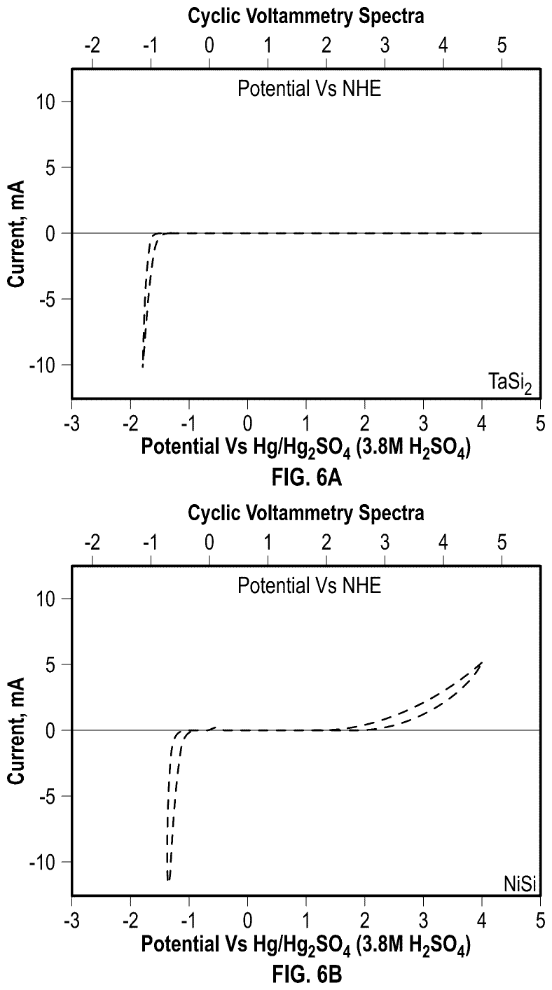

FIG. 6A and FIG. 6B show illustrative examples comprising cyclic voltammetry spectra of tantalum disilicide (TaSi₂) and nickel silicide (NiSi) layers. The electrochemical stability window of TaSi₂ and NiSi are indicated by the flat region with very low current between 0.95V to +0.95V in each of FIG. 6A and FIG. 6B.

Generally, a contact layer as described herein can provides a barrier to prevent corrosive electrolyte such as sulfuric acid from attacking the underlying substrate, allowing use of a substrate material that may have attractive mechanical features such as stiffness and low cost, but which may otherwise be subject to corrosion by the electrolyte. Such a contact layer need not be a conductive silicide or a conductive nitride. For example, a thin layer of metal can be deposited on one or more surfaces of the current collector substrate without requiring formation or deposition of a silicide or a nitride. For example, the metal can be specified based on resistance to sulfuric acid corrosion or having a specified electrochemical window for operation in a battery. Tantalum (Ta) and titanium (Ti) are two examples of such metal.

Optionally, in relation to the examples described in this document, one or more additional “adhesion” layers can be deposited on metal silicide or metal nitride surfaces to improve adhesion between the active materials of a lead acid battery and the conductive metallic current collector. For example, a layer of lead, tin, lead-tin alloy, or lead-containing alloys can be deposited on one or more surfaces of a metal silicide current collector prior to application of active materials. In an example, a lead or lead alloy foil can be sandwiched between the metal silicide surface and the active materials.

### Further Examples Concerning Processing of a Current Collector Substrate, Such as for Formation of an Adhesion Layer

Various approaches can be used to fabricate or otherwise process a current collector assembly for a bipolar battery. For example, if a substrate comprising silicon is used, a texture etch process can be used to remove saw damage and native oxide on the silicon surface. A contact layer can be formed on the cleaned surface to render the surface conductive and electrochemically stable. Another layer, such as an adhesion layer, can be deposited, such as by electroplating, to facilitate active material paste adhesion.

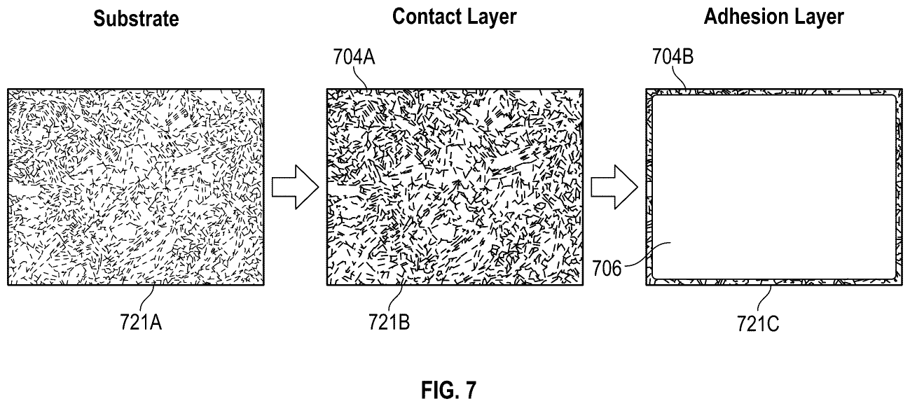

FIG. 7 shows an illustrative example of processing of a conductive metallic current collector, such as including forming a contact layer, and forming an adhesion layer. At 721A, a conductive current collector can be provided, such as fabricated from amorphous or polycrystalline silicon that has been or can be doped to a specified conductivity, or comprising a metallic species (e.g., a conductive metallic current collector) other than silicon. As mentioned above, the conductive current collector can be cleaned or even etched in preparation for further processing.

At 721B, a contact layer 704A can be formed, such as comprising a metal silicide (as shown illustratively in FIG. 7) or comprising a metal nitride. As discussed in various examples above, if the substrate of a conductive metallic current collector can form a binary metal silicide, a silicon layer can be deposited, and the assembly can be annealed to provide the contact layer at 721B. In another approach, as discussed above, a silicon layer and a metal layer different from a metallic species of the conductive metallic current collector can be deposited, such as to form a silicide through annealing, or through direct co-deposition.

At 721C, an adhesion layer 706 can be formed, such as not extending to the full surface area of the current collector assembly leaving an edge-exclusion region of the contact layer 704B exposed at a perimeter of the current collector assembly.

In the example of FIG. 7, at 721C, a lead-tin alloy layer can be formed as an adhesion layer, such as to promote adhesion of a later-applied active material to the surface of the current collector assembly.

In the example of a lead acid deep-cycle battery, a thickness of a PbSn adhesion layer may affect cycle life because sulfuric acid slowly corrodes the electrolyte layer at the positive electrode of the cell during cycling. The PbSn adhesion layer can provide a “corrosion reserve” at the positive electrode. Accordingly, a relatively thicker PbSn adhesion layer may provide a greater “reserve”” at the positive electrode as compared to the negative electrode. As an illustrative (but non-limiting) example, it is estimated that 100 micrometers (mm) of adhesion layer thickness would correspond to a life of 800 charge-discharge cycles.

Generally, electroplating is one approach that can be used to deposit an adhesion layer. For example, 100 μm of PbSn can be electroplated to both sides of the bipolar current collector. However, deposition of thick films using electroplating can be inefficient (e.g., slow) and therefore such processing may impact production throughput. Also, if both sides of the current collector are exposed, the same amount of material may be deposited on both sides of the current collector, resulting in unnecessary extra lead on one of the faces. In another approach, a screen-printing technique can be used, in a manner similar to eutectic lead paste application for reflow soldering, or in a manner similar to silver paste application for photovoltaic cell contact layer formation in solar applications.

A conductive substrate can be processed, such as to provide a contact layer (e.g., a silicide or other layer). The substrate can be cleaned, such as etched, to provide a clean, unoxidized surface. A metal paste or other metallic species can be applied to the electrode using a screen-printing technique (e.g., through a stencil or paste mask). For example, the screen printed (e.g., pasted) area can be smaller in extent than dimensions of the substrate such as to provide an edge exclusion around the perimeter of the screen-printed region. For example, if the substrate is a square 150 mm on a side, the pasted region may be centered in this square and have dimensions of 140 mm on a side. The substrate is then annealed (or otherwise heat treated), for example, by running it through a belt furnace. This annealing process can drive out fillers or a carrier from the paste, converting the paste into a molten metal, which solidifies to form a metallic layer covering and adhering to a planar surface when cooled.

The processing techniques mentioned above may be used to form an adhesion layer on opposite sides of the current collector, either contemporaneously or sequentially. The adhesion layers need not be the same thickness on both sides. For example, an adhesion layer can be at least 25 micrometers thick, such as on one or both faces of a substrate. As an example, a paste can be applied separately to both sides and then both sides can be annealed contemporaneously. Following formation of one or more adhesion layers, positive and negative active mass layers may be applied using pasting or other techniques. In an illustrative example, the metal in the paste is lead. In another example, the paste contains a mixture of metals, such as lead and tin, such as for enhanced compatibility with lead-acid battery chemistry (e.g., suitable for exposure to sulfuric acid). In another example, a lead or lead-tin foil having a specified adhesion layer thickness (e.g., 25 μm or 100 μm) can be laminated to the surface of the substrate using, for example, a heated roller.

In an example, a combination of different processes can be used to establish the adhesion layer. For example, electroplating may be used to form a very thin lead or lead-tin layer, and another process such as lamination or screen printing can be used to establish a thicker lead or lead-tin layer. In this manner, the electroplated layer can serve as a base layer or seed layer on which additional material can be deposited without compromising the quality of the interface between the base electrodeposited layer and an underlying contact layer.

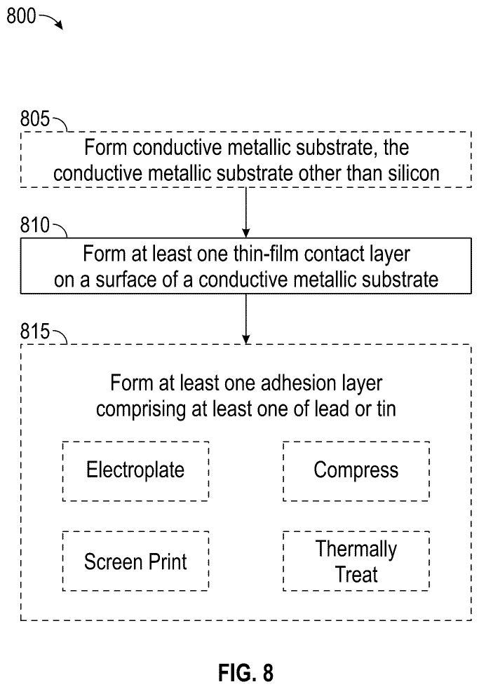

FIG. 8 illustrates generally a technique 800, such as a method, for providing a metallic current collector for a bipolar lead acid battery. At 810, at least one thin-film contact layer can be formed on a surface of a conductive metallic current collector. Such a contact layer can be formed deposition or annealing, to provide a thin-film contact layer that is conductive. Such a contact layer can include a conductive silicide or a conductive nitride (or a combination of a silicide and a nitride, such as a mixed layer). A conductive silicide or a conductive nitride can be formed using one or more techniques discussed elsewhere herein, such as including forming a metal silicide or a metallic nitride from a metallic species comprising the substrate of the conductive metallic current collector that can form a constituent of the silicide or the nitride, or by deposition of a specified metal different from a metallic species comprising the substrate, along with silicon. In another example, the thin-film contact layer need not be a conductive silicide or a conductive nitride, and can include tantalum or titanium, for example.

At 815, at least one adhesion layer can be formed, the adhesion layer comprising at least one of lead or tin. For example, such formation can include one or more of electroplating, screen printing, compression (e.g., lamination), or thermal treatment, or combinations thereof. Optionally, the technique 800 can include forming the conductive metallic substrate at 805, such as by stamping, molding, cutting, or machining a structure to provide a conductive metallic substrate having specified dimensions. The conductive metallic substrate can be in wafer, plate, sheet, or foil form. Processing of the conductive metallic substrate can include cleaning or etching the substrate prior to formation of the thin-film contact layer at 810.

### Various Notes

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A metallic current collector for a bipolar lead acid battery, the metallic current collector comprising:
a conductive metallic substrate other than silicon; and
at least one thin-film contact layer comprising a conductive nickel silicide or a conductive nickel nitride;
wherein a first surface of the metallic current collector comprises a first active material having a first polarity and an opposite second surface of the metallic current collector comprises a second active material having an opposite second polarity.

2. The metallic current collector of claim 1, wherein the conductive metallic substrate comprises a metal that can form a constituent of the conductive nickel silicide or the conductive nickel nitride.

3. The metallic current collector of claim 1, wherein the at least one thin-film contact layer comprising the conductive nickel silicide or the conductive nickel nitride comprises a metallic species forming the conductive metallic substrate.

4. The metallic current collector of claim 1, wherein the at least one thin-film contact layer comprising the conductive nickel silicide or the conductive nickel nitride comprises a metal different from a metallic species forming the conductive metallic substrate.

5. The metallic current collector of claim 1, wherein the conductive metallic substrate comprises at least one of a wafer, a plate, a sheet, or a foil comprising a metal, the metal comprising at least one of aluminum (Al), copper (Cu), lead (Pb), nickel (Ni), tin (Sn), titanium (Ti), iron (Fe), or tantalum (Ta).

6. The metallic current collector of claim 1, wherein the conductive metallic substrate comprises at least one of a wafer, a plate, a sheet, or a foil comprising an alloy, the alloy comprising a stainless steel, a Hastelloy® material, an Ultimet® material, or a Monel® material.

7-8. (canceled)

9. The metallic current collector of claim 1, comprising at least one adhesion layer between an active material layer and the at least one thin-film contact layer, the at least one adhesion layer comprising lead, a lead-tin alloy, or another lead-containing alloy.

10. The metallic current collector of claim 1, comprising at least one adhesion layer between an active material layer and the at least one thin-film contact layer, the at least one adhesion layer comprising tin.

11. A method for providing a metallic current collector for a bipolar lead acid battery, the method comprising:
forming at least one thin-film contact layer on a surface of a conductive metallic substrate, the at least one thin-film contact layer comprising a conductive nickel silicide, the conductive metallic substrate other than silicon; and
forming at least one adhesion layer comprising at least one of lead or tin;
wherein the forming the at least one thin-film contact layer comprises at least one of (1) deposition or (2) annealing.

12. The method of claim 11, wherein the conductive metallic substrate comprises a metal that can form a constituent of a conductive nickel silicide.

13. The method of claim 11, wherein the at least one thin-film contact layer comprising the conductive nickel silicide comprises a metallic species forming the conductive metallic substrate.

14. The method of claim 11, wherein the at least one thin-film contact layer comprising the conductive nickel silicide comprises a metal different from a metallic species forming the conductive metallic substrate.

15. (canceled)

16. The method of claim 11, wherein the conductive nickel silicide is deposited directly on the conductive metallic substrate without requiring annealing.

17. The method of claim 11, wherein the conductive nickel silicide is formed by:
depositing a metal film comprising nickel on at least one surface of the conductive metallic substrate,
depositing silicon on the metal film; and
annealing the deposited metal film and the silicon.

18. The method of claim 11, wherein the conductive nickel silicide is formed by:
depositing silicon on at least one surface of the conductive metallic substrate,
depositing a metal film comprising nickel on the silicon; and
annealing the deposited metal film and the silicon.

19. (canceled)

20. The method of claim 11, wherein the at least one adhesion layer comprises a lead-tin alloy, or another lead-containing alloy.

21. The method of claim 11, wherein the at least one adhesion layer comprises tin.

22. The method of claim 11, wherein the at least one adhesion layer is deposited by electroplating.

23. The method of claim 22, wherein the electroplating is followed by application of further adhesion layer material using a technique other than electroplating.

24. The method of claim 11, wherein the at least one adhesion layer is applied to the at least one thin-film contact layer thermally, or using compression, or using a combination of thermal application and compression forces.

25. The method of claim 11, wherein the at least one adhesion layer is applied using a lamination process.

26. The method of claim 11, wherein the at least one adhesion layer is applied using screen printing.

27. A bipolar battery assembly, comprising at least one metallic current collector, the at least one metallic current collector comprising:
a conductive metallic substrate other than silicon;
at least one thin-film contact layer comprising a conductive nickel silicide; and
at least one adhesion layer comprising at least one of lead or tin;
wherein a first surface of the at least one metallic current collector comprises a first active material having a first polarity and an opposite second surface of the at least one metallic current collector comprises a second active material having an opposite second polarity.
